(19) United States
(12) Patent Application Publication
(10) Pub. No.: US 2016/0109701 A1
(43) Pub. Date: Apr. 21, 2016

(54) SYSTEMS AND METHODS FOR ADJUSTING FEATURES WITHIN A HEAD-UP DISPLAY

(71) Applicant: GM GLOBAL TECHNOLOGY OPERATIONS LLC, Detroit, MI (US)

(72) Inventors: CLAUDIA V. GOLDMAN-SHENHAR, MEVASSERET ZION (IL); THOMAS A. SEDER, NORTHVILLE, MI (US)

(21) Appl. No.: 14/514,664

(22) Filed: Oct. 15, 2014

(51) Int. Cl. G02B 27/01

(52) U.S. Cl. CPC G02B 27/0101; G02B 2027/0118; G02B 2027/0112

(57) ABSTRACT

The present disclosure relates to systems that adapt information displayed onto a head-up display (HUD) based on context. The present disclosure also relates, generally, to methods for context awareness and methods for HUD image compensation. In one embodiment, the systems include a processor and a computer-readable storage device comprising instructions that cause the processor to perform operations for providing context-based assistance to a vehicle user. The operations include, in part, the system parsing information that can be projected on the HUD and selecting therefrom information relevant to current context indicating an environmental condition and/or a user-physiological condition. For example, based on contextual information, operations of the system dynamically adjust optical attributes of the HUD.

### TECHNICAL FIELD

The present technology relates to adjusting features on a head-up display. More specifically, the technology relates to adjusting features on a head-up display based on contextual inputs to allow an enhanced user experience.

### BACKGROUND

A head-up display, or HUD, is a display that presents data in a partially transparent manner and at a position allowing a user to see it without having to look away from his/her usual viewpoint (e.g., directly in front of him/her). Although developed for military use, HUDs are now used in commercial aircraft, automobiles, computer gaming, and other applications.

HUD images presented from virtual image forming systems are typically located in front of a windshield of the vehicle, e.g., 1 to 3 meters from the driver's eye. Alternately, HUD images presented from transparent display technology appear at the location of the transparent display, typically at the windshield.

Within vehicles, HUDs can be used to project virtual images or vehicle parameter data in front of the vehicle windshield or surface so that the image is in or immediately adjacent to the operator's line of sight. Vehicle HUD systems can project data based on information received from operating components (e.g., sensors) internal to the vehicle to, for example, notify users of lane markings, identify proximity of another vehicle, or provide nearby landmark information.

HUDs may also receive and project information from information systems external to the vehicle, such as navigational system on a smartphone. Navigational information presented by the HUD may include, for example, projecting distance to a next turn and current speed of the vehicle as compared to a speed limit, including an alert if the speed limit is exceeded. External system information advising what lane to be in for an upcoming maneuver or warning the user of potential traffic delays can also be presented on the HUD.

One issue with present HUD technology for vehicles is that the HUD systems typically contain fixed system parameters. These system parameters are almost always preset (e.g., from the factory). Additionally, the HUD system parameters are typically fixed, offering the user few, if any, options to adjust to changing conditions.

Some HUDs automatically adjust a brightness level associated with the display, so projections are clearly visible in direct sunlight or at night. The ability to adjust brightness is typically based only on the existence of an ambient light sensor that is sensitive to diffuse light sources. However, other forms of light, e.g., from spatially directed sources in the forward field, may not prompt a change in the brightness level of the HUD and the displayed image may not be clearly visible.

Furthermore, present HUD technology does not allow adjustment of other preset system parameters, except specific adjustments in the brightness level. Specifically, the preset system parameters do not have the ability to adjust based on changing conditions internal or external to the vehicle.

### SUMMARY

The need exists for systems and methods to adjust a HUD based on environmental and user-physiological inputs. The proposed systems and methods identify features of the HUD that can be adjusted to provide an enhanced user experience.

It is an objective of the present technology to create customized projections to the user based on changing environmental conditions and user behavior conditions. User attributes (e.g., height or eye level), prior user actions and preferences of the user are considered in customizing the display. Customized projections can thus create an experience that is appropriate for environmental conditions and personalized for the user within the vehicle based on previous user interaction with the vehicle.

The present disclosure relates to systems that adapt and adjust information present, such as how it is displayed (e.g., projected) onto the HUD, based on context, e.g., driver attributes (e.g., height), driver state, external environment, vehicle state. The systems can, e.g., adjust how information is displayed on the basis of attributes of the HUD background image, such as chromaticity, luminance. Output, or output-feature characteristics for adjustment include, e.g., display brightness, texture, contrast, coloring, or light-quality related characteristics, size, and positioning or location within a display area, for example.

The systems include a processor for implementing a computer-readable storage device comprising instructions that cause the processor to perform operations for providing assistance to a vehicle user.

The operations include, in part, the system parsing a wide variety of information from vehicle systems and subsystems that can be projected on the HUD and selecting information relevant to current driving context (e.g., environment and/or user behavior conditions). The data derived from the parsing and selecting operations is referred to as context data.

Additionally, based on the context data, operations of the system dynamically adjust or adapt optical attributes (e.g., image background optical attributes such as chromaticity and luminance of the forward scene) of the HUD.

Finally, the context data is in some embodiments presented at an appropriate position in a field of view of the user.

The present disclosure also relates to methods and systems for context awareness and for HUD image compensation. The methods are similar to the above described operations of the system.

Other aspects of the present invention will be in part apparent and in part pointed out hereinafter.

### DESCRIPTION OF THE DRAWINGS

FIG. 1 illustrates schematically an adjustable head-up display system in accordance with an exemplary embodiment.

FIG. 2 is a block diagram of a controller of the HUD system in FIG. 1.

FIG. 3 is a flow chart illustrating an exemplary sequence of the controller of FIG. 2.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components herein in connection with one or more functions is to be interpreted to cover embodiments in which a single component performs the function(s).

In some instances, well-known components, systems, materials or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

While the present technology is described primarily in connection with a vehicle in the form of an automobile, it is contemplated that the technology can be implemented in connection with other vehicles such as, but not limited to, marine craft, aircraft, machinery, and commercial vehicles (e.g., buses and trucks).

### I. OVERVIEW OF THE DISCLOSURE

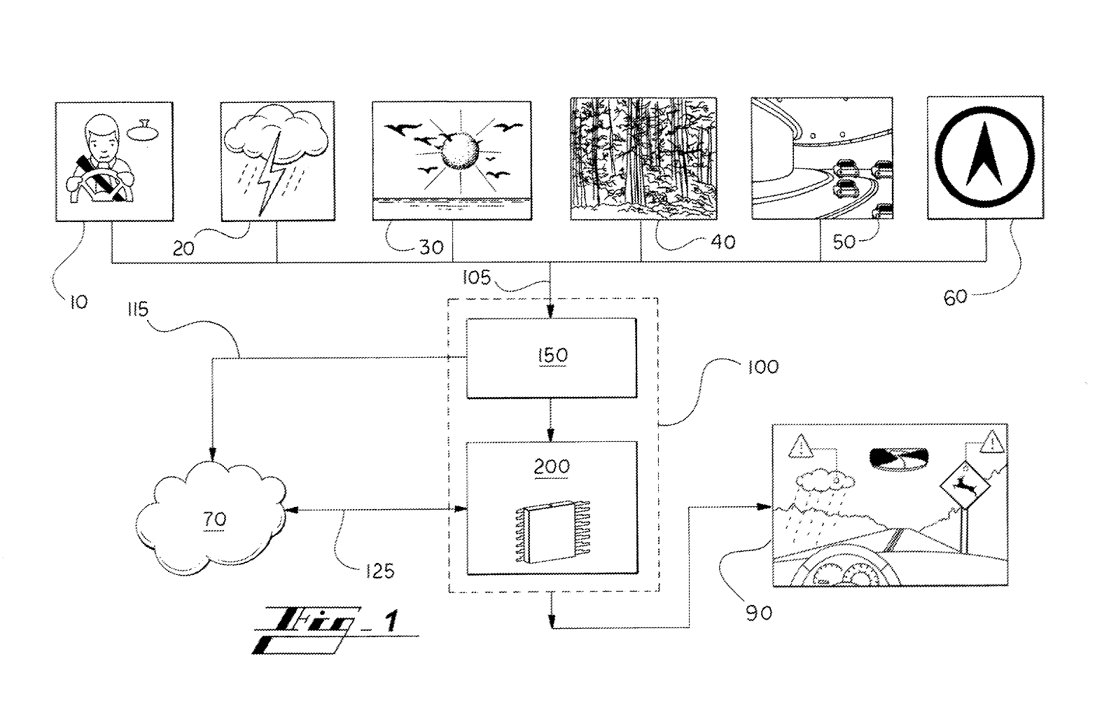

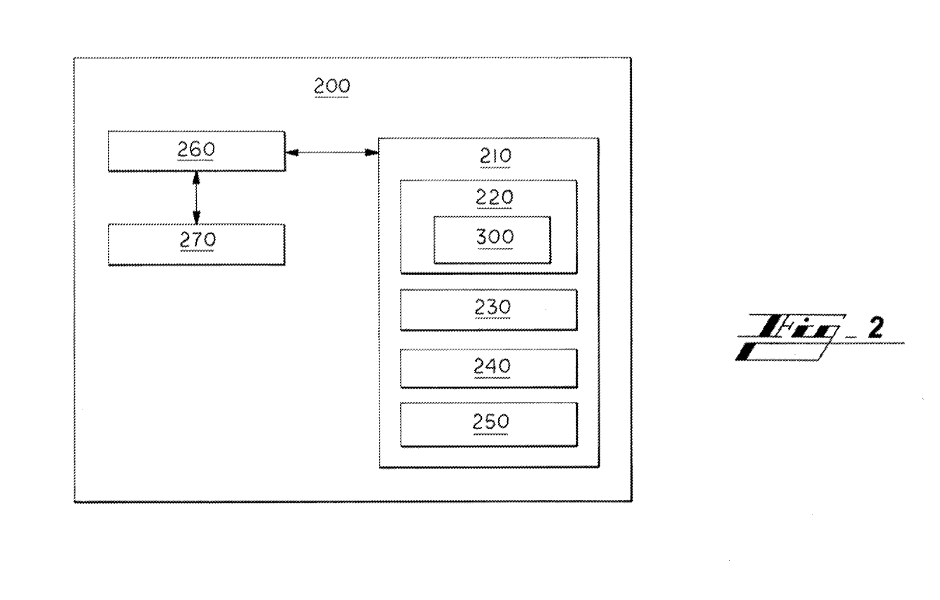

### FIGS. 1 and 2

Now turning to the figures, and more particularly to the first figure, FIG. 1 shows an adjustable head-up display (HUD) system 100 including a context recognizer 150 and a controller 200. In some embodiments, the context recognizer 150 can be constructed as part of the controller 200.

Received into the context recognizer 150, are a plurality of inputs 105. Based on its programming and one or more inputs, the HUD system 100 generates or controls (e.g., adjusts) an image to be presented, which is projected onto an output display 90.

The inputs 105 may include data perceived by sensors providing information about conditions internal to the vehicle and external to the vehicle. Conditions perceived internal to the vehicle include user-psychological conditions (e.g., user state 10), among others. Environmental conditions external to the vehicle include, e.g., weather conditions 20, luminance conditions 30, chromaticity conditions 40, traffic conditions 50, and navigation conditions 60, among others. The system 100 may take into consideration the inputs 105 to adjust features on the output display 90 ultimately presented to the user.

The user state conditions 10 in one embodiment represents information received by one or more human-machine interfaces within the vehicle. The user state conditions 10 could also include user settings or preferences, such as preferred seat position, steering angle, or radio station. Sensors within the vehicle may sense user attributes, such as driver height of eye level, and/or physiological behavior of the user while in the vehicle. For example, sensors may monitor blink rate of the driver, which may indicate drowsiness. As another example, sensors may capture vehicle positioning with reference to road lanes or with respect to surrounding vehicles to monitor erratic lane changing of the driver. The system 100 may take into consideration such user settings, attributes, and information from user-vehicle interfaces, such as physiological behavior, when adjusting user state features to ultimately present to the user.

The weather conditions 20 represents information associated with the conditions outside of the vehicle. Sensors internal and/or external to the vehicle may perceive weather conditions that affect the vehicle operation such as, temperature, moisture, ice, among others. The system 100 may take these characteristics into consideration when adjusting HUD display weather condition features to present to the user.

The luminance conditions 30 represents information associated with lighting characteristics that would affect the display, such as brightness (e.g., amount of background or foreground light) in and/or surrounding the vehicle. Adjustments in HUD image luminance can be made to account for changes in ambient lighting (e.g., reduced ambient light when entering a tunnel, increased ambient light when there exists a glare due to bright clouds). Adjustments in luminance can also be made to account for other forms of lighting such as florescent or incandescent (e.g., in a parking garage or building). For example, when lighting conditions within the vehicle change, e.g. an interior dome light is activated, the HUD image luminance can be accordingly adjusted.

The chromaticity conditions 40 represents information associated with characteristics of the background e.g., as seen through the vehicle windshield. Chromaticity assesses attributes of a color, regardless of luminance of the color, based on hue and colorfulness (saturation). Chromaticity characteristics can include color, texture, brightness, contrast, and size, among others of a particular object. The system 100 may take these characteristics into consideration when adjusting HUD display chromaticity features to present to the user.

The traffic conditions 50 represents information associated with movement, of vehicles and/or pedestrians, through an area. Specifically, the traffic conditions perceive congestion of vehicles through the area. For example, the system 100 may receive information that future road traffic will likely increase (e.g., rush hour or mass exodus from a sporting event). The system 100 may take traffic into consideration when adjusting traffic condition features to present to the user.

The navigation conditions 60 represents information associated with a process of accurately ascertaining positioning of the vehicle. The navigation conditions 60 also represents information associated with planning and following a particular route for the vehicle. For example, a vehicle may be given turn-by-turn directions to a tourist attraction. The system 100 may take into consideration GPS when adjusting navigation features to present to the user.

In addition to user-psychological conditions and environmental conditions, the inputs 105 may include vehicle conditions (not illustrated). Vehicle conditions are different than environmental conditions, and may include sensor readings pertaining to vehicle data, for example, fluid level indicators (e.g., fuel, oil, brake, and transmission) and wheel speed, among others. Readings associated with vehicle conditions typically provide warnings (e.g., lighting a low fuel indicator) or potential failure of a vehicle system (e.g., lighting a “check engine” indicator) to the user for a future response (e.g., add fuel to vehicle or obtain service for the engine).

In some situations vehicle conditions may be combined with user-psychological conditions, environmental conditions, or both, and presented as information into the context recognizer 150. As an example, when a vehicle has a low fuel level (e.g., as recognized by a fuel gauge indicator) and the user is near a gas station (e.g., as recognized from information on a GPS), a vehicle condition and an environmental condition concurrently exist. In this situation, the system 100 may present a change in color of the fuel gauge indicator (e.g., from of amber to red) as a response inform the user of the low fuel level and proximity of the gas station.

In one embodiment, the system 100 can use one or more vehicle conditions, user-psychological conditions, and/or environmental conditions to determine another user-psychological condition or an environmental condition. For example, the system 100 could use a coordinate location and/or direction of travel (e.g., from a GPS) combined with a time of day (e.g., from an in-vehicle clock display) to determine a potential luminance condition. Thus, when a vehicle is heading in an east direction during a time of sunrise, the HUD image luminance can be accordingly adjusted.

The context recognizer 150 includes adaptive agent software configured to, when executed by a processor, perform recognition and adjustment functions associated with the inputs 105. The context recognizer 150 serves as an agent for the output display 90, and determines how and where to display the information received by the inputs 105.

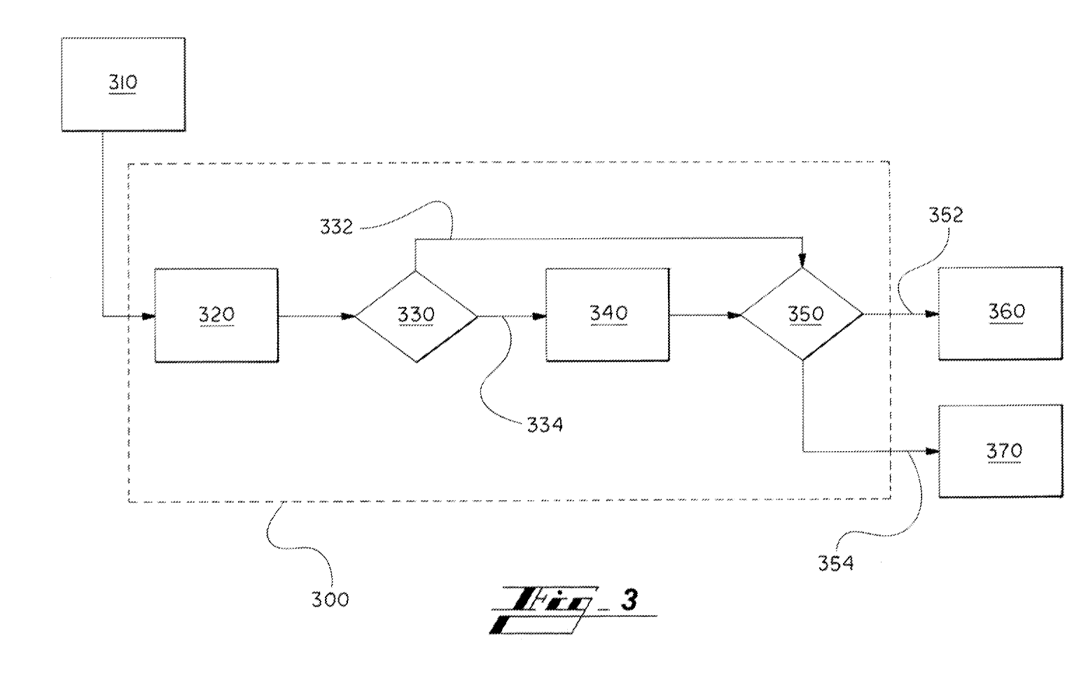

The context recognizer 150 may recognize user input such as, information received by one or more human-machine interfaces within the vehicle, including, specific inputs into a center stack console of the vehicle made by the user, a number of times the user executes a specific task, how often the user fails to execute a specific task, or any other sequence of actions captured by the system in relation to the user interaction with an in-vehicle system. For example, the context recognizer 150 can recognize that the user has set the pixilation of text and/or graphics displayed on the output display 90 to a specific color. As later described in association with FIG. 3, the system 100 can adjust (e.g., outline, increase brightness of, change color of) the text and/or graphics to emphasize features.

The context recognizer 150 may also process external inputs received by sensors internal and external to the vehicle. Data received by the context recognizer 150 can include vehicle system and subsystem data, e.g., data indicative of cruise control function. As an example, the context recognizer 150 can recognize when the luminance of the background has changed (e.g., sunset). As later described in association with FIG. 3, the system 100 can adjust the luminance of the output display 90 to be more clearly seen by the user in dim conditions, for example.

Both internal and external inputs are in some embodiments processed according to code of the context recognizer 150 to generate a set of context data to be used in setting or adjusting the HUD.

The context data generated by the context recognizer 150 can be constructed by the system 100 and optionally stored to a repository 70, e.g., a remote database, remote to the vehicle and system 100. The context data received into the context recognizer 150 may be stored to the repository 70 by transmitting a context recognizer signal 115. The repository 70 can be internal or external to the system 100.

The data stored to the repository 70 can be used to provide personalized services and recommendations based on the specific behavior of the user (e.g., inform the user about road construction). Stored data can include actual behavior of a specific user, sequences of behavior of the specific user, and the meaning of the sequences for the specific user, among others.

The data is stored within the repository 70 as computer-readable code by any known computer-usable medium including semiconductor, magnetic disk, optical disk (such as CD-ROM, DVD-ROM) and can be transmitted by any computer data signal embodied in a computer usable (e.g., readable) transmission medium (such as a carrier wave or any other medium including digital, optical, or analog-based medium).

The repository 70 may also transmit the stored data to and from the controller 200 by a controller transmission signal 125. Additionally, the repository 70 may be used to facilitate reuse of certified code fragments that might be applicable to a range of applications internal and external to the monitoring 100.

In embodiments where the context recognizer 150 is constructed as part of the controller 200, the controller transmission signal 125 may transmit data associated with both the context recognizer 150 and the controller 200, thus making the context recognizer signal 115 unnecessary.

In some embodiments, the repository 70 aggregates data across multiple users. Aggregated data can be derived from a community of users whose behaviors are being monitored by the system 100 and may be stored within the repository 70. Having a community of users allows the repository 70 to be constantly updated with the aggregated queries, which can be communicated to the controller 200 via the signal 125. The queries stored to the repository 70 can be used to provide personalized services and recommendations based on large data logged from multiple users.

FIG. 2 illustrates the controller 200, which is an adjustable hardware. The controller 200 may be a microcontroller, microprocessor, programmable logic controller (PLC), complex programmable logic device (CPLD), field-programmable gate array (FPGA), or the like. The controller may be developed through the use of code libraries, static analysis tools, software, hardware, firmware, or the like. Any use of hardware or firmware includes a degree of flexibility and high-performance available from an FPGA, combining the benefits of single-purpose and general-purpose systems.

The controller 200 includes a memory 210. The memory 210 may include several categories of software and data used in the controller 200, including, applications 220, a database 230, an operating system (OS) 240, and I/O device drivers 250.

As will be appreciated by those skilled in the art, the OS 240 may be any operating system for use with a data processing system. The I/O device drivers 250 may include various routines accessed through the OS 240 by the applications 220 to communicate with devices and certain memory components.

The applications 220 can be stored in the memory 210 and/or in a firmware (not shown) as executable instructions and can be executed by a processor 260.

The applications 220 include various programs, such as a context recognizer sequence 300 (shown in FIG. 3) described below that, when executed by the processor 260, process data received into the context recognizer 150.

The applications 220 may be applied to data stored in the database 230, such as the specified parameters, along with data, e.g., received via the I/O data ports 270. The database 230 represents the static and dynamic data used by the applications 220, the OS 240, the I/O device drivers 250 and other software programs that may reside in the memory 210.

While the memory 210 is illustrated as residing proximate the processor 260, it should be understood that at least a portion of the memory 210 can be a remotely accessed storage system, for example, a server on a communication network, a remote hard disk drive, a removable storage medium, combinations thereof, and the like. Thus, any of the data, applications, and/or software described above can be stored within the memory 210 and/or accessed via network connections to other data processing systems (not shown) that may include a local area network (LAN), a metropolitan area network (MAN), or a wide area network (WAN), for example.

It should be understood that FIG. 2 and the description above are intended to provide a brief, general description of a suitable environment in which the various aspects of some embodiments of the present disclosure can be implemented. While the description refers to computer-readable instructions, embodiments of the present disclosure can also be implemented in combination with other program modules and/or as a combination of hardware and software in addition to, or instead of, computer readable instructions.

The term “application,” or variants thereof, is used expansively herein to include routines, program modules, programs, components, data structures, algorithms, and the like. Applications can be implemented on various system configurations including single-processor or multiprocessor systems, minicomputers, mainframe computers, personal computers, hand-held computing devices, microprocessor-based, programmable consumer electronics, combinations thereof, and the like.

One or more output displays 90 are used to communicate the adjusted feature to the user. For example, the output display 90 can be a HUD built into the vehicle or a HUD add-on system, projecting the display onto a glass combiner mounted on the windshield.

The output display 90 provides visual information to a vehicle occupant about changing features (e.g., changing position of objects detected in a surrounding environment). For example, the output display 90 may display text, images, or video within the vehicle (e.g., front windshield).

The output display 90 may be combined with auditory or tactile interfaces to provide additional information to the user. As another example, the output component may provide audio speaking from components within the vehicle (e.g., speakers).

The system 100 can include one or more other devices and components within the system 100 or in support of the system 100. For example, multiple controllers may be used to recognize context and produce adjustment sequences.

The system 100 has been described in the context of a visual HUD. However, the principles of the system 100 can be applied to one or more other sensory modes (e.g., haptic and auditory) in addition to or alternative to the visual mode. For example, software of the system 100 can be configured to generate or control communications to a user (e.g., haptic or auditory communications) in a manner, or by characteristics tailored to context such as the user (e.g., user attributes, actions, or state) and/or environmental conditions.

Auditory output features include, e.g., tones or verbal notifications. Adjustable output-feature characteristics regarding auditory features include, e.g., tone, volume, pattern, and location (e.g., which speakers to output from or at what volume speakers are to output).

Adjustable haptic output features include, e.g., vibration, temperature, and other appropriate haptic feedback. Adjustable output-feature characteristics regarding haptic features, such as vibration and temperature, include location (e.g., steering wheel and/or seat), timing or pattern (e.g., direction) for the output at the appropriate part(s) or location(s), harshness of haptic output, or other appropriate haptic or auditory characteristics).

### II. METHODS OF OPERATION

### FIG. 3

FIG. 3 is a flow chart illustrating methods for performing a context recognizer sequence 300.

It should be understood that the steps of the methods are not necessarily presented in any particular order and that performance of some or all the steps in an alternative order, including across these figures, is possible and is contemplated.

The steps have been presented in the demonstrated order for ease of description and illustration. Steps can be added, omitted and/or performed simultaneously without departing from the scope of the appended claims. It should also be understood that the illustrated method or sub-methods can be ended at any time.

In certain embodiments, some or all steps of this process, and/or substantially equivalent steps are performed by a processor, e.g., computer processor, executing computer-executable instructions, corresponding to one or more corresponding algorithms, and associated supporting data stored or included on a computer-readable medium, such as any of the computer-readable memories described above, including the remote server and vehicles.

The sequence 300 begins by receiving inputs 105 by the system 100 at step 310. The software may be initiated through the controller 200. The inputs 105 may be received into the system 100 according to any of various timing protocols, such as continuously or almost continuously, or at specific time intervals (e.g., every ten seconds), for example. The inputs 105 may, alternately, be received based on a predetermined occurrence of events (e.g., activation of the output display 90 or a predetermined condition, such as a threshold level of extra-vehicle brightness being sensed.

Next, at step 320, the system 100 receives one or more of the inputs 105 into the context receiver 150. In some embodiments, the inputs 105 may contain an original feature which can be displayed to the user at the output display 90. In other embodiments, the original feature can be generated within the context receiver 150. The inputs 105 are in some embodiments processed (e.g., stored and used) based on the type of input.

For example, data from vehicle motion sensors (e.g., speed, acceleration, and GPS sensors) can be received into a portion of the context recognizer 150 that recognizes vehicle state data. Specialized sensors (e.g., radar sensors) would be received into a portion of the context recognizer that recognizes the specific characterization of the camera. For example, a radar sensor information could be received into a system such as an advanced driver assistance system (ADAS).

Physiological sensors (e.g., blink rate sensors) would be received into a portion of the context recognizer 150 that recognizes user state data.

Information from external vehicle sensors (e.g., traffic sensors, weather sensors, visual editor sensors) would be received into a portion of the context recognizer 150 that recognizes external environmental data.

Information from scene cameras (e.g., front and/or rear mounted cameras) would be received into a portion of the context recognizer 150 that recognizes external environmental data, image data, and/or scene data. Information from specialized cameras (e.g., infrared cameras) would be received into a portion of the context recognizer 150 that recognizes the specific characterization of the camera. For example, an infrared camera can have information received into night vision imaging system (NVIS).

Next, at step 330, the system 100 according to the sequence 300 determines whether the original feature received into and/or generated by the context receiver 150 should be adjusted based on the context data. The original feature may need to be adjusted based on any of the inputs 105. For example, the original feature may need to be adjusted based on the user state conditions 10.

If adjustment of the original feature is not necessary (e.g., path 332), the assistance of the system 100 is not required. For example, if the user is decelerating to turn into a gas station (e.g., as recognized from information on a GPS), there may not be a need for the system 100 to present an alert to the user regarding a low fuel level.

When adjustment of the original feature is not necessary (e.g., path 332), the original feature is presented to the user without edit. In one embodiment, however, first the system 100, at step 350, or another point in the sequence 300, determines if an intended display location (e.g., a position on the driver's side of a windshield) is impaired. The display location may be impaired if the user cannot easily view the information. For example, the front driver side of the windshield may be impaired when the driving in an east direction during sunrise.

If adjustment of the original feature is determined needed (e.g., path 334), the original feature is adjusted based on the context data at step 340. Adjustment of the original feature can occur by the controller 200 executing a set of code instructions stored within the controller 200 or the repository 70, for example.

The code instructions are a set of predetermined rules that, when executed by the controller 200, produce an adjusted feature which can be presented to the user. The adjusted feature may be based on context data from the user state conditions 10, the weather conditions 20, the luminance conditions 30, the chromaticity conditions 40, the traffic conditions 50, and the navigation conditions 60.

In some embodiments, the set of code instructions executed by the controller 200 may produce the adjusted feature based on the user state conditions 10. As an example, when the user turns on the left signal of the vehicle, the system 100 can emphasize (e.g., visually highlight, audibly speak) businesses (e.g., restaurants, gas stations) that will appear when the turn is executed. As another example, when the user is distracted by a secondary task (e.g., phone call, radio tuning, menu browsing, conversation with a passenger), the system 100 can enlarge fonts or change the display to get the attention of the user.

Additionally, the system 100 assesses the user state conditions 10 within the forward scene for threats and highlights these threats if the system 100 determines that the user has not perceived and acted upon the threats in the same manner as an automated system. As an example, if the user does not begin to apply the brakes when a ball rolls into the street, the system 100 may highlight the ball to bring the object into a perceptual field of the user when displayed by the output display 90.

The HUD can include components associated with virtual or augmented reality (AR) in some embodiments. When the system 100 perceives user state conditions 10, the system 100 can change the AR to provide adjusted features to the user. For example, if the user does not decelerate (e.g., near 0 miles per hour) when approaching a stop sign, the system 100 may highlight the stop sign to make it noticeable to the driver. Conversely, if the user decelerates the vehicle, the system 100 may not decides not to highlight the stop sign. As another example, when the user turns on the left signal of the vehicle, the system 100 can emphasize businesses (e.g., restaurants, gas stations) that will appear when the turn is executed. The HUD can include an arrow pointing to the left wherein the arrow tip points actually to the actual building from the driver's perspective.

In some embodiments, the set of code instructions executed by the controller 200 may produce the adjusted feature based on the weather conditions 20. As an example, on wet roads, an indicator of safe speeds, wheel slip, and non-use of cruise control systems may be adjusted within the system 100 and displayed on the output display 90.

In some embodiments, the set of code instructions executed by the controller 200 may produce the adjusted feature based on the luminance conditions 30. For example, upon entering a tunnel, luminance of the output display 90 may dim and tunnel safety information may be indicated. Safety information such as, appropriate distance for following a vehicle ahead, no horn sounding, and no lane changes may be adjusted within the system 100 and displayed as indicators on the output display 90. Additionally, if the usual location of the output information is impaired (e.g., driving into a sunset), the system 100 may present the information an alternate position.

In some embodiments, the set of code instructions executed by the controller 200 may produce the adjusted feature based on the chromaticity conditions 40. Displayed information (e.g., text and/or graphics) may be adjusted and/or outlined with a chromaticity that is distinguishable from the chromaticity of the ambient background. As an illustrative example, where snow covers the road, displayed information (e.g., text and/or graphics) on the output display 90 information normally presented in white may be adjusted to a more visible color (e.g., green). Similarly, where green trees appear the background, displayed information that is normally presented in green may be adjusted to white or another more visible color.

In some embodiments, the set of code instructions executed by the controller 200 may produce the adjusted feature based on the traffic conditions 50. For example, if the system 100 determines that road traffic will likely increase (e.g., rush hour or mass exodus from a sporting event), they system 100 may adjust a traffic change strategic indictor and display on the indicator on the output display 90 to enable the driver to take actions to avoid a sudden onset of traffic.

In some embodiments, the set of code instructions executed by the controller 200 may produce the adjusted feature based on the navigation conditions 60. For example, a bus may have a tourist attraction presented as the bus gets within a certain range of the attraction. To this point, the code instructions executed by the controller 200 can also produce the adjusted feature based on timing or occurrence of a specific task, such as proximity to the attraction.

The set of code instructions within the system 100 can be determined by a relevant domain. For example, where the system 100 is associated with a marine environment, the relevant domain may include adjusted features associated with e.g., maximum heading control parameters. As another example, where the system 100 is associated with a construction machinery, the relevant domain may include adjusted features associated with e.g., equipment and/or markings of utility service companies.

Once any adjusting has occurred, the adjusted feature is then ready to be presented to the user. As stated above, at step 350, the system 100 determines if an intended display location (e.g., driver's side of a windshield) is impaired.

When no impairment exists (e.g., path 352), the original feature or the adjusted feature, if necessary, is displayed at the original display location at step 360.

When an impairment exists (e.g., path 354), the original feature or the adjusted feature is displayed at an alternate display location at step 370. The alternate display location may be a location that is easily viewed by the driver. The alternate display location should allow the content of the presented information to be readily viewed by the user. For example, in a transparent display HUD, where the driver's side of the windshield is impaired when driving east during sunrise, the system 100 may choose to have the projection on the passenger side of the windshield.

Displaying in the alternate location can also include changes in characteristics of the projection including, font of display, colors used within the display, among others.

The presentation of the original feature or the adjusted feature can occur on one or more output devices (e.g., output display 90 for a HUD).

In one embodiment, determining the intended display location (e.g., step 350) is not present. In another embodiment, the display location is an adjustable characteristic of the feature (e.g., color and/or brightness), and the operation of determining whether the original feature should be modified (e.g., step 330) includes determining whether a display location for the feature should be modified. In this implementation, adjusting the feature at step 340 would include changing a display location for the feature if determined appropriate or needed in step 330. Once the original feature is adjusted, if necessary, at step 340, the adjusted feature will be presented to the user at an output location as explained above.

### III. SELECT FEATURES

Many features of the present technology are described herein above. The present section presents in summary some selected features of the present technology. It is to be understood that the present section highlights only a few of the many features of the technology and the following paragraphs are not meant to be limiting.

One benefit of the present technology is the system present information relevant to current driving context. In prior systems, static format image projections are possible, but not context-based information. Presenting contextual information (e.g., context data) can add significantly utility (e.g., relevance, reduced clutter) to the HUD system.

Another benefit of the present technology is the system dynamically adjust/adapt optical attributes of the HUD. Adjustment/adaptation compensates for contextual information and may increase visual comprehension, by the user, of the presented images, resulting in streamlined HUD usability.

### IV. CONCLUSION

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A computer-readable storage device comprising instructions that, when executed by a processor, cause the processor to perform operations, associated with providing a context-based output feature to a vehicle user, comprising:
receiving input data comprising a context data component indicating one or both of an environmental condition and a user-physiological condition;
determining, based on the input data, a manner by which to adjust a characteristic of a notification feature to emphasize the notification feature; and
adjusting the characteristic according to the manner determined to emphasize the notification feature, yielding the context-based output feature.

2. The computer-readable storage device of claim 1 wherein:
the operations further comprise identifying, based on the input data, the characteristic of the notification feature to be adjusted; and
the determining operation is performed in response to the identifying operation.

3. The computer-readable storage device of claim 1 wherein:
the determining operation is a second determining operation;
the operations further comprise determining, in a first determining operation, whether the output feature should be adjusted; and
the second determining and adjusting operations are performed in response to determining in the first determining operation that the notification feature should be adjusted.

4. The computer-readable storage device of claim 1 wherein:
the characteristic includes display position;
the determining operation comprises determining how to adjust the display position of the notification feature to emphasize the notification feature; and
the adjusting operation comprises adjusting the display position to yield the context-based output feature.

5. The computer-readable storage device of claim 1 wherein the operations further comprise determining a display position for the context-based output feature.

6. The computer-readable storage device of claim 1 wherein the characteristic comprises at least one visual characteristic selected from a group consisting of color, weight, display position, brightness, texture, and contrast.

7. The computer-readable storage device of claim 1 wherein the characteristic comprises (i) at least one haptic characteristic from a group consisting of vibration, temperature, pattern, and location, or (ii) at least one auditory characteristic selected from a group consisting of tone, volume, pattern, and location.

8. A system, comprising:
a processor; and
a computer-readable storage device including instructions that, when executed by the processor, cause the processor to perform operations, for providing a context-based output feature to a vehicle user, comprising:
receiving input data comprising a context data component indicating one or both of an environmental condition and a user-physiological condition;
determining, based on the input data, a manner by which to adjust a characteristic of a notification feature to emphasize the notification feature; and
adjusting the characteristic according to the manner determined to emphasize the notification feature, yielding the context-based output feature.

9. The system claim 8 wherein:
the operations further comprise identifying, based on the input data, the characteristic of the notification feature to be adjusted; and
the determining operation is performed in response to the identifying operation.

10. The system of claim 8 wherein:
the determining operation is a second determining operation;
the operations further comprise determining, in a first determining operation, whether the output feature should be adjusted; and
the second determining and adjusting operations are performed in response to determining in the first determining operation that the notification feature should be adjusted.

11. The system of claim 8 wherein:
the characteristic includes display position;
the determining operation comprises determining how to adjust the display position of the notification feature to emphasize the notification feature; and
the adjusting operation comprises adjusting the display position to yield the context-based output feature.

12. The system of claim 8 wherein the operations further comprise determining a display position for the context-based output feature.

13. The system of claim 8 wherein the characteristic comprises at least one visual characteristic selected from a group consisting of color, weight, display position, brightness, texture, and contrast.

14. The system of claim 8 wherein the characteristic comprises (i) at least one haptic characteristic from a group consisting of vibration, temperature, pattern, and location, or (ii) at least one auditory characteristic selected from a group consisting of tone, volume, pattern, and location.

15. A method, for providing a context-based output feature to a vehicle user using instructions, comprising:
receiving, by a system comprising a processor, input data comprising a context data component indicating one or both of an environmental condition and a user-physiological condition; and
determining, based on the input data, a manner by which to adjust a characteristic of a notification feature to emphasize the notification feature; and
adjusting, by the system, the characteristic according to the manner determined to emphasize the notification feature, yielding the context-based output feature.

16. The method of claim 15 further comprising:
identifying, based on the input data, the characteristic of the notification feature to be adjusted, wherein the determining is performed in response to the identifying.

17. The method of claim 15 further comprising:
determining whether the output feature should be adjusted, wherein the adjusting is performed in response to determining that the notification feature should be adjusted.

18. The method of claim 15 wherein:
the characteristic includes display position;
the determining comprises determining how to adjust the display position of the notification feature to emphasize the notification feature; and
the adjusting comprises adjusting the display position to yield the context-based output feature.

19. The method of claim 15 further comprising determining a display position for the context-based output feature.

20. The system of claim 15 wherein the characteristic comprises (i) at least one visual characteristic selected from a group consisting of color, weight, display position, brightness, texture, and contrast, (ii) at least one haptic characteristic from a group consisting of vibration, temperature, pattern, and location, or (iii) at least one auditory characteristic selected from a group consisting of tone, volume, pattern, and location.
